(19) United States
(12) Patent Application Publication
(10) Pub. No.: US 2008/0316167 A1
(43) Pub. Date: Dec. 25, 2008

(54) DISPLAY DRIVER

(76) Inventors: Yoshiki KUROKAWA, Tokyo (JP); Yukari Katayama, Chigasaki (JP); Yasuyuki Kudo, Fujisawa (JP); Akihito Akai, Yokohama (JP); Goki Toshima, Yokohama (JP); Akihisa Aoyama, Kokubunji (JP)

Correspondence Address: MATTINGLY, STANGER, MALUR & BRUNDIDGE, P.C., 1800 DIAGONAL ROAD, SUITE 370, ALEXANDRIA, VA, 22314, US

(21) Appl. No.: 12/134,726

(22) Filed: Jun. 6, 2008

(30) Foreign Application Priority Data
Jun. 19, 2007 (JP) 2007-160910

(51) Int. Cl. G09G 3/36

(52) U.S. Cl. 345/102

(57) ABSTRACT

A display driver driving a display panel according to inputted display data comprises: a first circuit changing brightness of a display image by conversion of the display data based on a first reference value and a second reference value, the first reference value being a display data value at a first position in an upper part of a histogram of the inputted display data, and the second reference value being a display data value at a second position in a lower portion of the histogram; a second circuit changing brightness of a illuminating device illuminating the display panel based on the first reference value; and a control circuit performing a processing of making the brightness of the display image high by the first circuit and a processing of making the brightness of the illuminating device low by the second circuit in correlation with the brightness of the display image.

### CROSS-REFERENCE TO RELATED APPLICATION

The present application claims priority from Japanese application serial No. 2007-160910 filed on Jun. 19, 2007, the content of which is hereby incorporated by reference into this application.

### TECHNICAL FIELD OF THE INVENTION

The present invention relates to a technology effective in applying to backlight control of a display device such as a liquid crystal display device, in particular, to backlight control capable of reducing power consumption while maintaining high contrast sensitivity.

### BACKGROUND OF THE INVENTION

In recent years, a liquid crystal display is mounted on battery-powered information instruments and cellular phones. These liquid crystal displays are mostly a transmission type and a semi-transmission type which needs a backlight. Now, most of power consumption of a liquid crystal display portion is consumed by the backlight, and therefore, an idea for reduction in the power consumption has been desired. Particularly in cellular phones, motion pictures, for example, television can be watched. As a result, a long time battery drive with keeping displaying a display has been required.

As an idea for reduction in power consumption of a backlight, for example, a method is disclosed in Japanese Patent Application Laid-Open Publication No. 11-65531. For example, when a backlight is emitted at 100%, and 80% of the emitted light is transmitted through a front liquid crystal cell, 80% of the backlight is visible. In this case, although the backlight is emitted at 100%, 20% of a backlight amount is reduced by the liquid crystal cell.

On the other hand, when the backlight is emitted at 80% and a liquid crystal cell is made 100% transmissive, 80% of the backlight is visible as well. However, emission of the backlight can be suppressed to 80%. In the method for backlight control disclosed in Japanese Patent Application Laid-Open Publication No. 11-65531, these differences are utilized to reduce power consumption by suppressing a light emission amount of the backlight.

In a histogram of display data of an image, when a pixel having 80% of luminance is the maximum luminance pixel, for displaying the image, an amount of the backlight is reduced to 80% that is ⅘ times thereof, and display data values of all pixels of the display image are expanded to 5/4 times of the values, thereby making it possible to display a totally identical image with 80% of the backlight emission amount.

Further, in focusing on pixels which are in the top several percent of a histogram, when this portion has 60% of luminance, the emission amount of the backlight is suppressed to 60% that is ⅗ of the amount, and the display data values of all pixels of the display image are expanded to 5/3 of the value, thereby making it possible to obtain a nearly identical image. In this case, compared to a method in which a maximum luminance in an image is utilized, a display can be displayed with a further small emission amount of the backlight.

However, in this case, as to the pixels (the pixels in the top several percent of the histogram described above) having a value higher than ⅗ of the maximum value to be taken by the display data, when the display data is expanded to 5/3 times of the data, the value becomes saturated to the maximum value. Because of this, in respect of the pixels, when the emission amount of the backlight is suppressed to ⅗ of the emission, the luminance becomes lower than the original luminance, and as a result, deterioration of the image quality is caused to some extent.

In recent years, high image quality sensitivity for small liquid crystal displays has been desired. As an example of enhancement of image quality sensitivity, displaying an image with high contrast can be listed. As this technique, for example, a technique of making contrast high by histogram expansion is disclosed in U.S. Pre-Grant Publication No. 2006/0050084 (Japanese Patent Application Laid-Open Publication No. 2006-73009).

In the histogram expansion, pixels in the top several percent and the bottom several percent of the histogram are focused on. Each pixel value is expanded to the maximum value and the minimum value that the display data value can take, for example, in the case where the display data is eight bits, the each pixel value is respectively expanded to 255 and 0. Each pixel whose value is higher than the pixel value at a position of the top several percent, and each pixel whose value is lower than the pixel value at a position of the bottom several percent are saturated to the maximum value and the minimum value. With this, a luminance difference between gradations can be made larger in pixels of half-tone gradation. As a result, an image with high contrast sensitivity can be displayed.

### SUMMARY OF THE INVENTION

The above described two conventional technologies have an aspect in common that pixels in the top several percent are saturated to the maximum value by means of a similar technique. Because of this, there are problems that contrast of an output image is lowered when power of the backlight is reduced by using the technology disclosed in Japanese Patent Application Laid-Open Publication No. 11-65531 and obtaining high contrast sensitivity by using the technology disclosed in U.S. Pre-Grant Publication No. 2006/0050084 (Japanese Patent Application Laid-Open Publication No. 2006-73009) becomes difficult.

Hence, an object of the present invention is, in a function of power saving of a backlight which uses a pixel histogram of an image, to reduce power consumption of the backlight while maintaining high contrast sensitivity of a display image by making contrast high as well as reducing power consumption.

The above and other objects and novel characteristics of the present invention will be apparent from the description of this specification and the accompanying drawings.

Typical ones of the inventions disclosed in this application will be briefly described as follows.

In a display driver of the present invention, histograms of an input image (for example, a histogram of an input image for one or a plurality of frames) are obtained in the upper part and the lower part of the gradation, and contrast expansion is performed based on the histogram. At this time, darkening of the backlight is performed at the same time in response to the expansion of an upper part side.

In conventional backlight control, darkening based on a reciprocal of an expansion rate (including an expansion amount) of the upper end side is performed. However, at this time, darkening is performed using a darkening amount (including a darkening rate) which is a value resulted from multiplying a reciprocal of an expansion rate by an adjustment amount (including an adjustment rate), and the darkening amount is suppressed to a value lower than the reciprocal of the expansion rate, thereby making the high contrast sensitivity high by an amount of the suppression of darkening. By making the adjustment amount large, the high contrast sensitivity of an image is emphasized, and by making the adjustment amount small, low power consumption of the backlight is emphasized.

Further, the adjustment amount is changed in response to a pixel saturation rate on the lower-gradation side. That is, when the pixel saturation rate is high, a relatively dark image is presumed, and therefore, the adjustment amount is made large, that is, the darkening amount of the backlight is made small to brighten the image. When the pixel saturation rate is low, a relatively bright image is presumed, and therefore, the adjustment amount is made small, that is, the darkening amount of the backlight is made large (or leave it as it is) to keep the image as it is. With this, the adjustment amount can be automatically adjusted according to the pixel saturation rate on the lower-gradation side.

Furthermore, by changing the adjustment amount in response to the expansion rate on the lower-gradation side, when the expansion rate is low, an image with relatively low contrast is presumed, and therefore, the adjustment amount is made large, that is, the darkening amount of the backlight is made small to brighten the image. When the expansion rate is high, an image with relatively high contrast is presumed, and therefore, the adjustment amount is made small, that is, the darkening amount of the backlight is made large (or leave it as it is) to keep the image as it is, so that the power consumption is reduced by the darkening amount.

The effects obtained by typical aspects of the present invention will be briefly described below.

According to the present invention, by the above-described first display driver, power consumption of the backlight can be reduced while remaining the high contrast sensitivity, which allows selection between an emphasis on the high contrast sensitivity and an emphasis on reduction in power consumption of the backlight depending on the adjustment amount.

Further, by the above-described second display driver, the adjustment amount is automatically adjusted. That is, a relatively dark image is brightened to increase the high contrast sensitivity, and it is presumed that a relatively bright image has the contrast sensitivity, so that power consumption of the backlight can be reduced.

Furthermore, by the third display driver, the adjustment amount is automatically adjusted. That is, when an image has relatively low contrast, the image is brightened to increase the high contrast sensitivity. When the image has relatively high contrast, the contrast sensitivity is presumed to be sufficient, so that power consumption of the backlight can be reduced.

### BRIEF DESCRIPTIONS OF THE DRAWINGS

FIG. 1 is a drawing representing a configuration of a liquid crystal display device including a liquid crystal driver of a first embodiment of the present invention;

FIG. 2 is a drawing representing a detailed inner configuration of a backlight control unit in the first embodiment of the present invention;

FIG. 3A is a drawing to explain a relation between histogram expansion and backlight darkening in the first embodiment of the present invention;

FIG. 3B is a drawing to explain a relation between histogram expansion and backlight darkening in the first embodiment of the present invention;

FIG. 3C is a drawing to explain a relation between histogram expansion and backlight darkening in the first embodiment of the present invention;

FIG. 3D is a drawing to explain a relation between histogram expansion and backlight darkening in the first embodiment of the present invention;

FIG. 4A is a drawing to explain an effect on an image by histogram expansion on a lower-gradation side in the first embodiment of the present invention;

FIG. 4B is a drawing to explain an effect on an image by histogram expansion on a lower-gradation side in the first embodiment of the present invention;

FIG. 5 is a drawing representing a detailed inner configuration of a backlight control unit in a second embodiment of the present invention;

FIG. 6 is a drawing representing a detailed inner configuration of a backlight control unit in a third embodiment of the present invention;

FIG. 7 is a drawing representing a detailed inner configuration of a backlight control unit in a fourth embodiment of the present invention; and

FIG. 8 is a drawing representing a detailed inner configuration of a backlight control unit in a fifth embodiment of the present invention.

### DESCRIPTIONS OF THE PREFERRED EMBODIMENTS

Hereinafter, embodiments of the present invention will be explained in detail with reference to the accompanying drawings. Note that in the all drawings for explaining the embodiments, same components are designated by same reference numerals in principle and the repetitious explanations thereof will be omitted.

The embodiments of the present invention are a display driver that realizes a backlight power saving function using a pixel histogram of an input image by reducing power consumption while making contrast of an output image high. Note that, as an example of a display panel, a liquid crystal panel is exemplified, however the display panel is not limited to the liquid crystal panel.

### First Embodiment

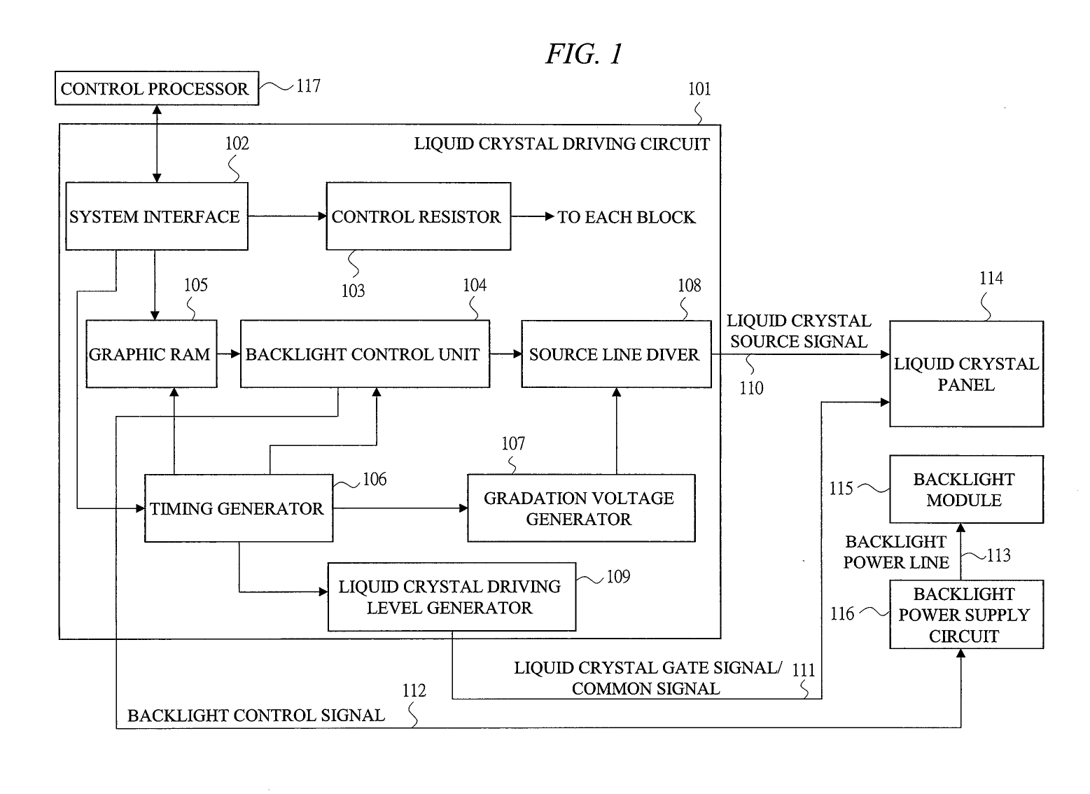

Hereinafter, a driver for a liquid crystal display device of a first embodiment of the present invention will be explained with reference to FIG. 1 to 4.

FIG. 1 is a drawing representing a configuration of the liquid crystal display device including the liquid crystal driver of the present embodiment. The liquid crystal display device includes a liquid crystal driver 101, a liquid crystal panel 114, a backlight module 115, a backlight power supply circuit 116, and a control processor 117.

The control processor 117 creates display data of an image and outputs it to the liquid crystal driver 101. The backlight power supply circuit 116 generates a desired voltage based on information of a backlight control signal 112 outputted from the liquid crystal driver 101 and supplies the voltage to a backlight power line 113. The liquid crystal panel 114 is inputted with a liquid crystal source signal 110 and a liquid crystal gate signal/common signal 111 from the liquid crystal driver 101 to display an image. The backlight module 115 receives a power supply through the backlight power line 113, turns on the backlight at a desired brightness, and illuminates the liquid crystal panel 114. Whereby, it is made possible to see the image displayed on the liquid crystal panel 114 as visible light.

The liquid crystal driver 101 includes a system interface 102, a control resistor 103, a backlight control unit 104, a graphic random access memory (RAM) 105, a timing generator 106, a gradation voltage generator 107, a source line diver 108, and a liquid crystal driving level generator 109.

The system interface 102 is an interface unit to the outside in the liquid crystal driver 101, and deliveries and receives the display data, written data to the control resistor 103 described later, and the like to the outside. The control resistor 103 is a group of resistors that controls each unit in the liquid crystal driver 101.

The backlight control unit 104 is a main block in the liquid crystal driver 101 of the present embodiment. The backlight control unit 104 is inputted with the display data from the graphic RAM 105 described later; performs display data expansion processing described later; and outputs the display data to the source line diver 108 described later.

The graphic RAM 105 is inputted with the display data via the system interface 102 to accumulate, and serves as a buffer that outputs the display data to the source line diver 108 via the backlight control unit 104. The timing generator 106 generates an operation timing for the entire liquid crystal driver 101 based on contents of the control resistor 103.

The gradation voltage generator 107 generates gradation voltages that are used for the source line diver 108. The source line diver 108 uses the display data outputted from the backlight control unit 104; selects a specific voltage from the gradation voltages generated by the gradation voltage generator 107; and outputs the selected voltage as the liquid crystal source signal 110 to the liquid crystal panel 114. The liquid crystal driving level generator 109 generates the liquid crystal gate signal/common signal 111 used for driving the liquid crystal panel 114 to output it to the liquid crystal panel 114.

An outline of the operation of the liquid crystal driver 101 according to the configuration described above will be explained as follows. The liquid crystal driver 101 fetches display data from the outside via the system interface 102 and stores it in the graphic RAM 105. The timing generator 106 generates a read-out timing for the graphic RAM 105, and the graphic RAM 105 inputs the display data to the backlight control unit 104 at the timing.

The backlight control unit 104 performs a display data expansion processing described later, and outputs the display data to the source line diver 108. The source line diver 108 selects a voltage from the gradation voltages generated by the gradation voltage generator 107 based on the inputted display data, and outputs the selected voltage to the liquid crystal panel 114 as the liquid crystal panel signal 110. Further, the liquid crystal driving level generator 109 generates the liquid crystal gate signal/common signal 111 with use of the timing generated by the timing generator 106, and outputs the signal to the liquid crystal panel 114.

By the backlight control signal 112 from the backlight control unit 104, the backlight power supply circuit 116 generates a voltage and applies it to the backlight power line 113, thereby turning on the backlight module 115. The backlight module 115 that is turned on illuminates the liquid crystal panel 114. Accordingly, a display image can be seen.

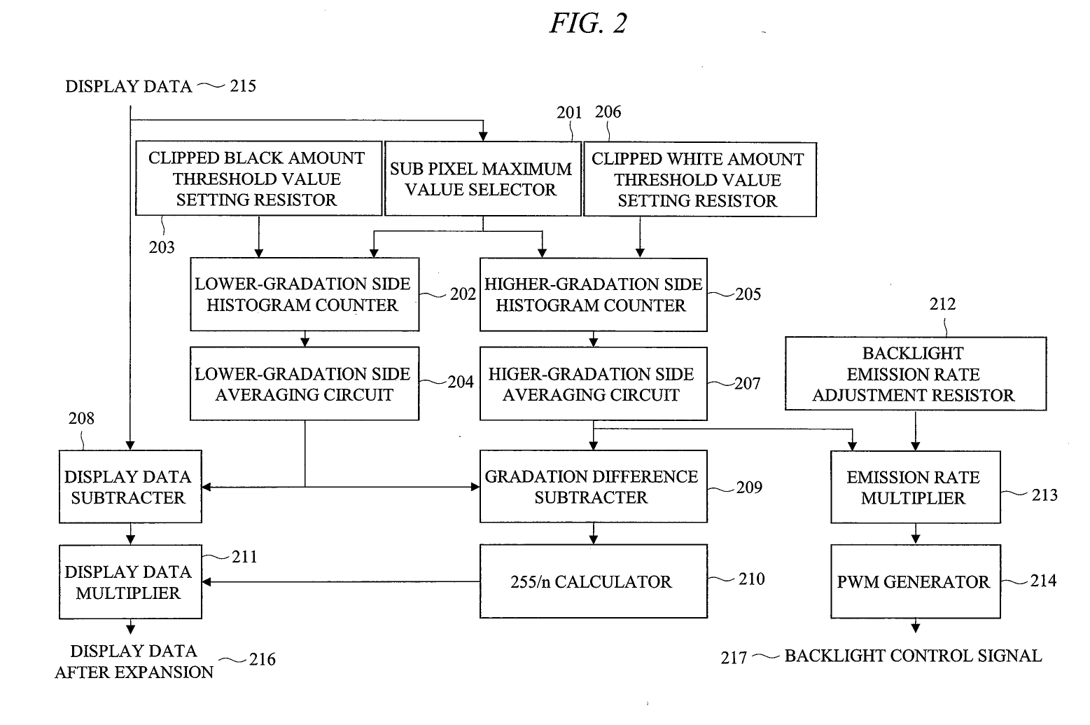

FIG. 2 is a drawing representing a detailed inner configuration of the backlight control unit 104. The backlight control unit 104 comprises a sub-pixel maximum value selector 201, a lower-gradation side histogram counter 202, a clipped black amount threshold value setting resistor 203, a lower-gradation side averaging circuit 204, a higher-gradation side histogram counter 205, a clipped white amount threshold value setting resistor 206, a higher-gradation side averaging circuit 207, a display data subtracter 208, a gradation difference subtracter 209, a 255/n calculator 210, a display data multiplier 211, a backlight emission rate adjustment resistor 212, an emission rate multiplier 213, and a PWM generator 214. The backlight control unit 104 is inputted with a display data 215, and outputs a display data after expansion 216 and a backlight control signal 217.

The sub pixel maximum value selector 201 selects a maximum value from each of red, green, and blue sub pixel gradation values of the display data 215, and transmits the maximum value to the lower-gradation side histogram counter 202 and the higher-gradation side histogram counter 205.

The lower-gradation side histogram counter 202 performs histogram counting of the maximum value of the sub pixel gradation value transmitted from the sub pixel maximum value selector 201. When counting for one frame is completed, the lower-gradation side histogram counter 202 compares the counted values with a value of the clipped black amount threshold value setting resistor 203, and obtains a gradation value that becomes the pixel number closest to the threshold value to transmit the gradation value to the lower-gradation side averaging circuit 204. The lower-gradation side averaging circuit 204 stores the gradation values of the plurality of frames, in which the gradation value for each frame is transmitted from the lower-gradation side histogram counter 202, and determines an average of the gradation values of the plurality of frames as the average for every frame to transmit the average to the display data subtracter 208 and the gradation difference subtracter 209.

The higher-gradation side histogram counter 205 performs histogram counting of the maximum value of the sub pixel gradation value transmitted from the sub pixel maximum value selector 201. When counting for one frame is completed, the higher-gradation side histogram counter 205 compares with the counted values with a value of the clipped white amount threshold value setting resistor 206, and obtains a gradation value that becomes the pixel number closest to the threshold value to transmit the gradation value to the higher-gradation side averaging circuit 207. The higher-gradation side averaging circuit 207 stores the gradation values of the plurality of frames, in which the gradation value for each frame is transmitted frame from the higher-gradation side histogram counter 205, and determines an average of the gradation values of the plurality of frames as the average for every frame to transmit the average to the gradation difference subtracter 209 and the emission rate multiplier 213.

The display data subtracter 208 subtracts an average gradation value on the lower-gradation side that is transmitted from the lower-gradation side averaging circuit 204 from each of the red, green, and blue sub pixel gradation values of the display data 215, and transmits the subtraction result to the display data multiplier 211. The gradation difference subtracter 209 subtracts an average gradation value on the lower-gradation side that is transmitted from the lower-gradation side averaging circuit 204 from an average gradation value on the higher-gradation side that is transmitted from the higher-gradation side averaging circuit 207 to determine a difference gradation value, and transmits the value to the 255/n calculator 210.

The 255/n calculator 210 divides the value of 255 by the difference gradation value transmitted from the gradation difference subtracter 209, and transmits a calculated pixel expansion value to the display data multiplier 211. The display data multiplier 211 multiplies each of the red, green, and blue sub pixel gradation values that are the result calculated by the display data subtracter 208 by the pixel expansion value transmitted from the 255/n calculator 210, and outputs the multiplication result as the display data after expansion 216.

The emission rate multiplier 213 multiplies the average gradation value on the higher-gradation side that is transmitted from the higher-gradation side averaging circuit 207 by a value of the backlight emission rate adjustment resistor 212, and transmits the result as a backlight PWM coefficient to the PWM generator 214. The PWM generator 214 uses the backlight PWM coefficient transmitted from the emission rate multiplier 213 to generate a PWM signal for dimming the backlight, and outputs the signal as the backlight control signal 217.

The flow of the entire process in the backlight control unit 104 according to the configuration described in the foregoing is as follows. First, when the display data 215 is inputted, the maximum gradation value is fetched among the sub pixel gradation values of the display data 215 by the sub pixel maximum value selector 201. The maximum gradation values for one frame are counted by the lower-gradation side histogram counter 202 and the higher-gradation side histogram counter 205. The calculation results for one frame are respectively compared with a value of the clipped black amount threshold value setting resistor 203 and a value of the clipped white amount threshold value setting resistor 206 to obtain the gradation values closest to the threshold values. An average of the plurality of frames is respectively determined by the lower-gradation side averaging circuit 204 for the lower-gradation side and the higher-gradation side averaging circuit 207 for the higher-gradation side to output a lower-gradation side expansion gradation value and a higher-gradation side expansion gradation value, respectively.

Next, the gradation difference subtracter 209 obtains a difference between the higher-gradation side expansion gradation value and the lower-gradation side expansion gradation value, and the 255/n calculator 210 determines the pixel expansion rate based on the value of the difference. Next, the display data 215 is processed by the display data subtracter 208 and the display data multiplier 211 to output the processed result as the display data after expansion 216. In the calculation, the display data subtracter 208 subtracts the lower-gradation side expansion gradation value from each value of the sub pixels, and the display data multiplier 211 performs the expansion processing to each sub pixel at each of the pixel expansion rates calculated by the 255/n calculator 210 to obtain the display data after expansion 216.

The emission rate multiplier 213 multiplies the higher-gradation side expansion gradation value by a value of the backlight emission rate adjustment resistor 212. The calculation result is converted to a PWM signal by the PWM generator 214 to output the signal as the backlight control signal 217.

Through the sequential operation, the higher-gradation side expansion gradation value and the lower-gradation side expansion gradation value are obtained based on the inputted display data 215 with use of the histogram. The display data 215 is expanded using this values, the backlight can be controlled in response to the higher-gradation side expansion gradation values. By making the value of the backlight emission rate adjustment resistor 212 larger than 1, the darkening amount of the backlight is reduced to realize a high contrast output. By making the value closer to 1, the darkening amount of the backlight is made close to the conventional backlight control to realize low power consumption.

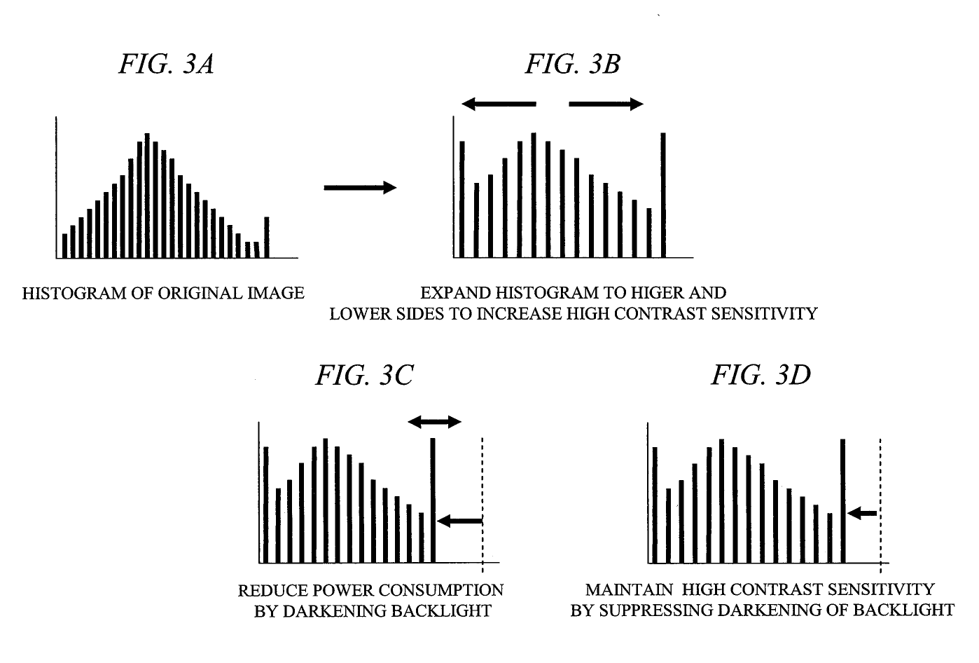

Next, with reference to FIG. 3, a relation between histogram expansion and backlight darkening will be explained. FIG. 3A is an example of a histogram of an image. The contrast sensitivity of the image is increased by expanding the histogram to the higher-gradation side and the lower-gradation side as shown in FIG. 3B. In respect of this, when the backlight is further darkened as shown in FIG. 3C, reduction in power consumption can be realized; however, the contrast sensitivity increased by means of the expansion shown in FIG. 3B is decreased. Hence, although the effect is decreased compared with that of FIG. 3C, low power consumption of the backlight can be realized by suppressing the backlight darkening as shown in FIG. 3D while maintaining the high contrast sensitivity.

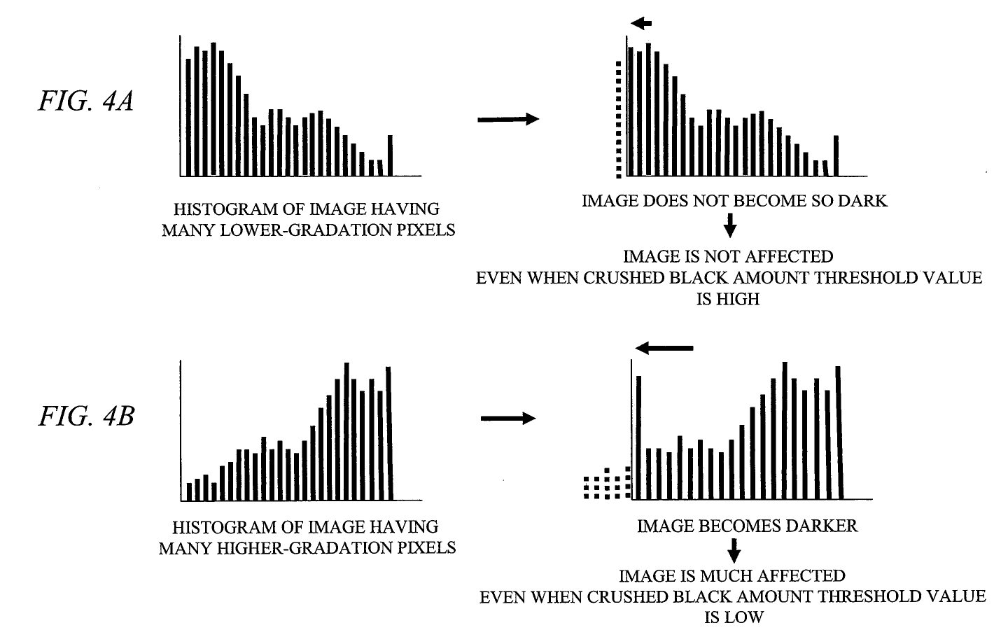

Next, with reference to FIG. 4, an effect on the image by histogram expansion on the lower-gradation side will be explained. FIG. 4A is an example of a histogram of an image having many lower-gradation pixels. Even though histogram expansion for the lower-gradation side of the image is performed, since there are many lower-gradation pixels, the gradation that becomes a clipped black amount threshold value is low. Accordingly, the expansion to the lower-gradation side does not work well, so that the image does not become so dark. Therefore, such an image is less affected even if the clipped black amount threshold value is high.

On the other hand, FIG. 4B is an example of a histogram of an image having many higher-gradation pixels. When histogram expansion for the lower-gradation side of the image is performed, since there are a small number of lower-gradation pixels, the gradation that becomes a clipped black amount threshold is high, so that the expansion to the lower-gradation side works well, as a result the image is dark. Therefore, the image is much affected even if the clipped black amount threshold value is low.

Accordingly, the clipped black amount threshold value is desirably set as low as possible within a range in which the effect of high contrast is remarkable. In respect of a low clipped black amount threshold value, in the case of the image of FIG. 4A, the effect on the image is not so much different from the effect in which a large value is set, and in case of the image of FIG. 4B, the effect on the image can be made small.

As explained in the foregoing, darkening is performed with use of a darkening amount (including a darkening rate) as a value resulted from the multiplication of a reciprocal of an expansion rate by an adjustment amount (including an adjustment rate), and the darkening amount is suppressed to a value smaller than the reciprocal, thereby making it possible to remain the high contrast sensitivity by the suppression amount of the darkening. Further, by making the adjustment amount large, the high contrast sensitivity of the image is emphasized. By making the adjustment amount small, low power consumption of the backlight is emphasized, and therefore, depending on the adjustment amount, selection between the emphasis on high contrast sensitivity and the emphasis on low power consumption of backlight is possible.

### Second Embodiment

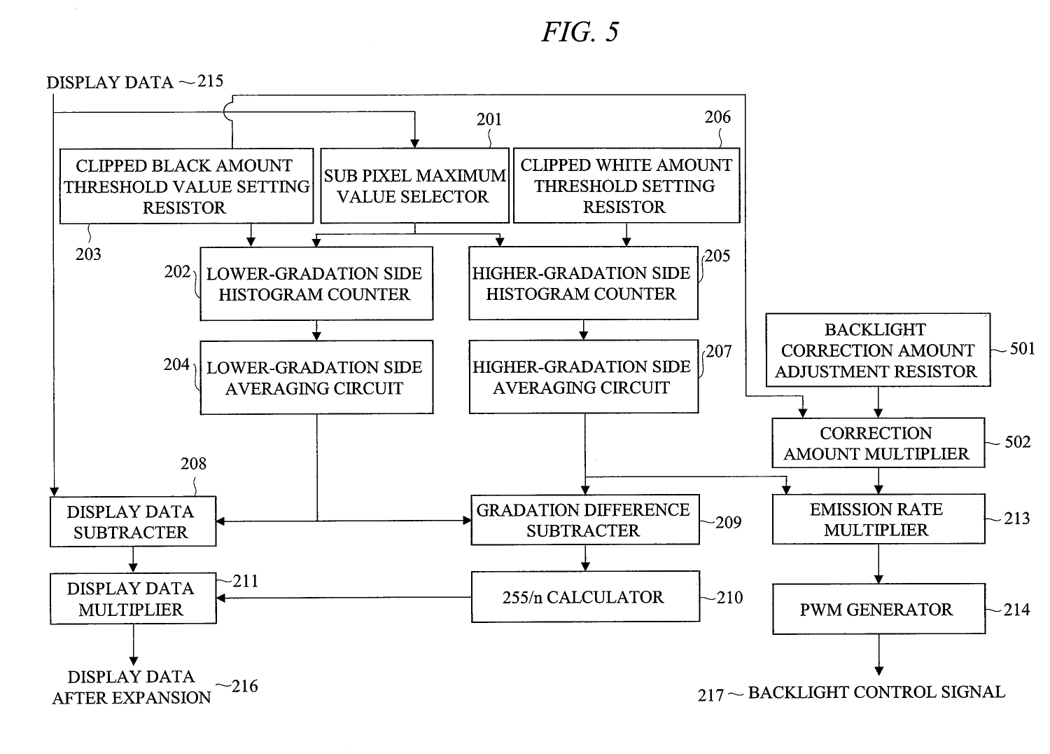

Hereinafter, a driver for a liquid crystal display device of a second embodiment of the present invention will be explained with reference to FIG. 5. The configuration of the liquid crystal display device including the liquid crystal driver of the present embodiment is similar to that of FIG. 1 of the first embodiment described above.

FIG. 5 is a drawing representing a detailed inner configuration of the backlight control unit 104 according to the present embodiment. In the configuration of FIG. 5, a backlight correction amount adjustment resistor 501 and a correction amount multiplier 502 are newly added in place of the backlight emission rate adjustment resistor 212 in the configuration of FIG. 2 of the first embodiment. The other components from the sub pixel maximum value selector 201 to the backlight control signal 217 are the same as those of the function block explained in FIG. 2 of the first embodiment, and therefore, the explanation thereof is omitted.

The correction amount multiplier 502 multiplies a value of the clipped black amount threshold value setting resistor 203 by a value of the backlight correction amount adjustment resistor 501, and transmits the multiplication result to the emission rate multiplier 213.

The flow of the entire process in the backlight control unit 104 according to the configuration described above is as follows. An explanation for from an input of the display data 215 to calculation of the display data after expansion 216 is similar to that of FIG. 2 of the first embodiment, and therefore, the explanation thereof is omitted. In the present embodiment, in order to generate the backlight control signal 217, an intensity of the backlight, which is determined according to the average gradation values on the higher-gradation side transmitted from the higher-gradation side averaging circuit 207, is controlled with use of the value of the clipped black amount threshold value setting resistor 203.

When the clipped black amount threshold value is high, it is expected that the expansion to the lower-gradation side becomes large and, as a result, the image becomes dark. Therefore, the brightness of the image is compensated by increasing the intensity of the backlight. When the clipped black amount threshold is low, it is expected that the expansion to the lower-gradation side is small and, as a result, the image does not become so dark. Therefore, an increase in power consumption due to the compensation is suppressed by not increasing the intensity of the backlight. The backlight correction amount adjustment resistor 501 allows control of the intensity that compensates the brightness from the outside.

As described above, an adjustment amount is changed in response to the pixel saturation rate on the lower-gradation side. When the pixel saturation rate is high, a relatively dark image can be presumed, and therefore, the adjustment amount is made large, that is, a darkening amount of the backlight is made small to brighten the image and increase the high contrast sensitivity. Further, when the pixel saturation rate is low, a relatively bright image can be presumed, and therefore, the adjustment amount is made small, that is, the darkening amount of the backlight is made large (or leave it as it is) to keep the image as it is. With this, it is made possible to adjust the adjustment amount automatically according to the pixel saturation rate on the lower-gradation side.

### Third Embodiment

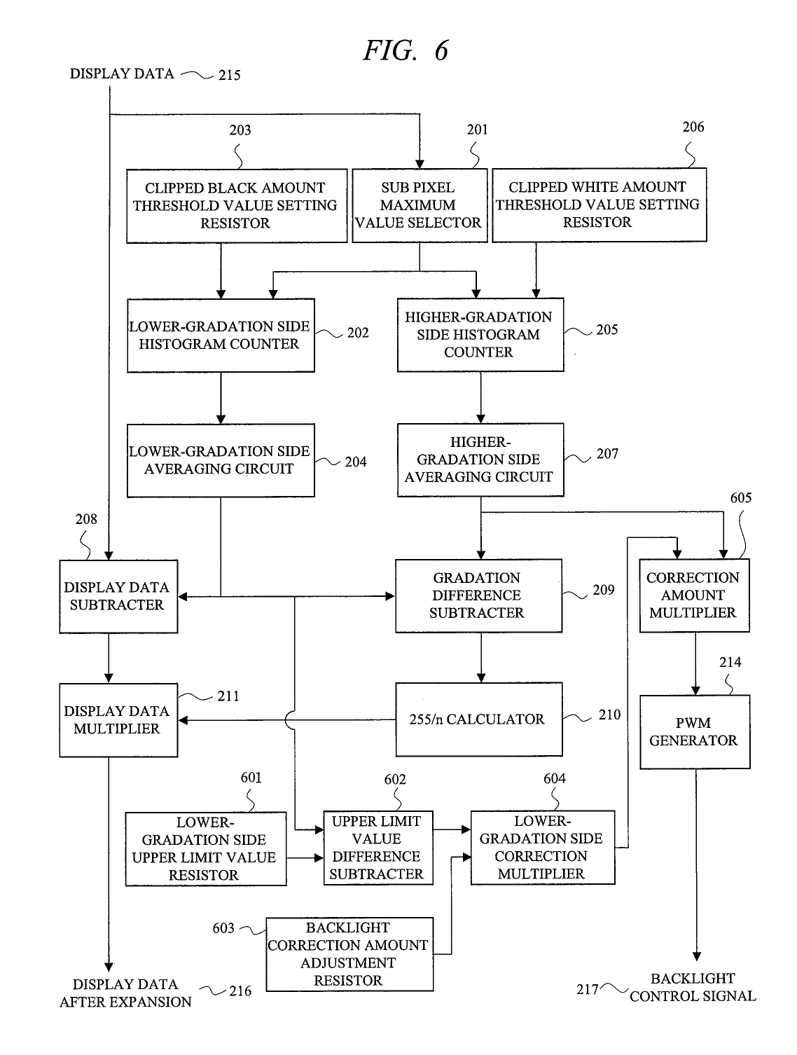

Hereinafter, a driver for a liquid crystal display device of a third embodiment of the present invention will be explained with reference to FIG. 6. The configuration of the liquid crystal display device including the liquid crystal driver of the present embodiment is similar to that of FIG. 1 of the first embodiment.

FIG. 6 is a drawing representing a detailed inner configuration of the backlight control unit 104 according to the present embodiment. In the configuration of FIG. 6, a lower-gradation side upper limit value resistor 601, an upper limit value difference subtracter 602, a backlight correction amount adjustment resistor 603, a lower-gradation side correction multiplier 604, and a correction amount multiplier 605 are newly added in place of the backlight emission rate adjustment resistor 212 and the emission rate multiplier 213 in the configuration of FIG. 2 of the first embodiment. The other components from the sub pixel maximum value selector 201 to the backlight control signal 217 are the same as those of the function block explained in FIG. 2 of the first embodiment. Therefore, the explanation thereof is omitted.

The upper limit difference subtracter 602 subtracts a lower-gradation side expansion gradation value that is an output of the lower-gradation side averaging circuit 204 from a value of the lower-gradation side upper limit value resistor 601, and outputs the subtraction result as a backlight correction amount before adjustment to the lower-gradation side correction multiplier 604. The lower-gradation side correction multiplier 604 multiplies the backlight correction amount before adjustment from the upper limit value difference subtracter 602 by a value of the backlight correction amount adjustment resistor 603, and transmits the multiplication result as a backlight correction amount to the correction amount multiplier 605. The correction amount multiplier 605 multiplies a higher-gradation side expansion gradation value that is an output of the higher-gradation side averaging circuit 207 by a backlight correction amount that is an output of the lower-gradation side correction multiplier 604, and transmits the multiplication result to the PWM generator 214.

The flow of the entire process in the backlight control unit 104 according to the configuration described above is as follows. An explanation for from an input of the display data 215 to calculation of the display data after expansion 216 is similar to that of FIG. 2 of the first embodiment, and therefore, the explanation thereof is omitted. In the present embodiment, in order to generate the backlight control signal 217, first of all, with use of the upper limit value difference subtracter 602, a difference between the value of the lower-gradation side upper limit value resistor 601 and the lower-gradation side expansion gradation value that is an output of the lower-gradation side averaging circuit 204 is obtained, and the difference is used as a correction amount of the backlight.

However, the correction amount is too large if as it is, and therefore, the lower-gradation side correction multiplier 604 multiplies the value of the backlight correction amount adjustment resistor 603 by the backlight correction amount before adjustment that is the above-described difference, thereby obtaining the backlight correction amount. The correction amount multiplier 605 multiplies this backlight correction amount by the higher-gradation side expansion gradation value that is an output of the higher-gradation side averaging circuit 207, and outputs the multiplication result as the corrected backlight emission amount to the PWM generator 214. The PWM generator 214 generates a PWM signal with use of the backlight emission amount to output the signal as the backlight control signal 217.

As described above, in the present embodiment, the darkening amount of the backlight is made to change in response to the lower-gradation side expansion gradation values. Accordingly, when the gradation of clipped black is large, high contrast is presumed because of the large gradation, and therefore the backlight is darkened to reduce the power consumption. When the gradation of clipped black is small, because of the small gradation, it is presumed that so high contrast does not occur, and therefore the backlight is less darkened, and the display is made brighter to compensate the contrast. With this, the high contrast sensitivity can be realized without depending on the gradation of clipped black, and at the same time, reduction in power consumption is possible by an amount in which power consumption of the backlight can be reduced.

### Fourth Embodiment

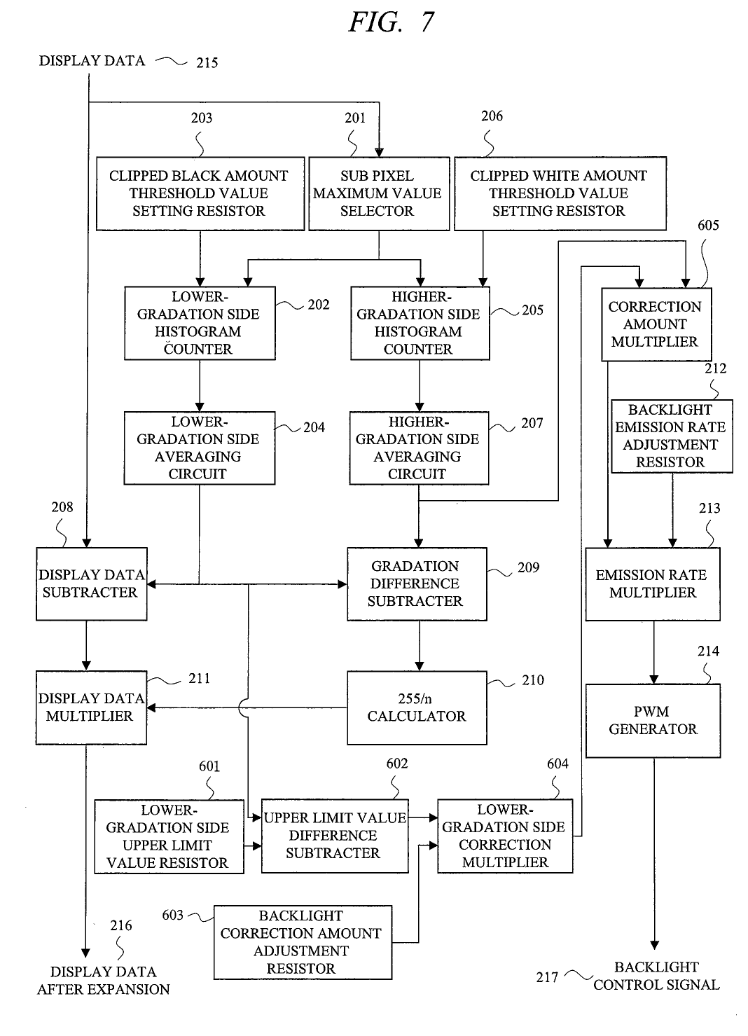

Hereinafter, a driver for a liquid crystal display device of a fourth embodiment of the present invention will be explained with reference to FIG. 7. The configuration of the liquid crystal display device including the liquid crystal driver of the present embodiment is similar to that of FIG. 1 of the first embodiment.

FIG. 7 is a drawing representing a detailed inner configuration of the backlight control unit 104 according to the present embodiment. In the configuration of FIG. 7, the lower-gradation side upper limit value resistor 601, the upper limit value difference subtracter 602, the backlight correction amount adjustment resistor 603, the lower-gradation side correction multiplier 604, and the correction amount multiplier 605, which are all added in FIG. 6 of the third embodiment, are newly added to the configuration of FIG. 2 of the first embodiment. The function block of the fourth embodiment is similar to those explained in FIG. 2 of the first embodiment and FIG. 6 of the third embodiment, and therefore, the explanation thereof is omitted.

The backlight control unit 104 according to the present embodiment is a combination of the backlight control unit 104 of the first embodiment and the backlight control unit 104 of the third embodiment. With this, a luminance of the backlight can be determined in consideration of both of the higher-gradation side histogram and the lower-gradation side histogram of the display image, and further, a ratio of the effect from the higher-gradation side histogram and a ratio of the effect by the lower-gradation side histogram can be independently adjusted.

### Fifth Embodiment

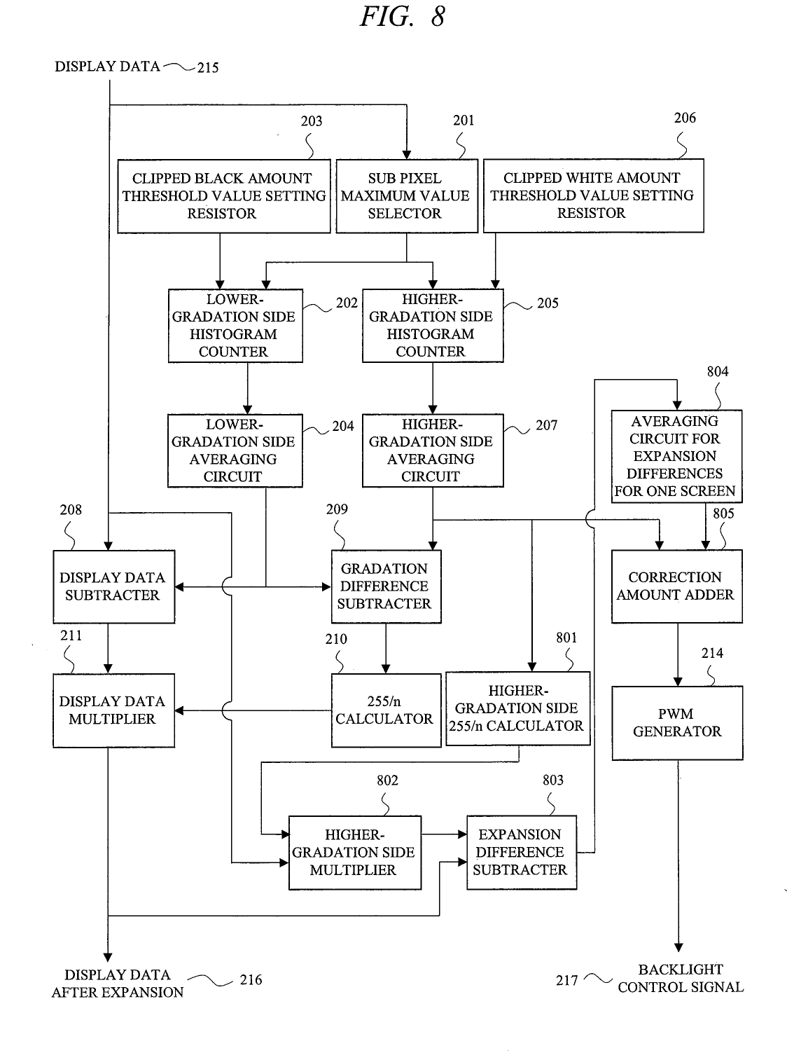

Hereinafter, a driver for a liquid crystal display device of a fifth embodiment of the present invention will be explained with reference to FIG. 8. The configuration of the liquid crystal display device including the liquid crystal driver of the present embodiment is similar to that of FIG. 1 of the first embodiment.

FIG. 8 is a drawing representing a detailed inner configuration of the backlight control unit 104 according to the present embodiment. In the configuration of FIG. 8, a higher-gradation side 255/n calculator 801, a higher-gradation side multiplier 802, an expansion difference subtracter 803, an averaging circuit for expansion differences for one screen 804, and a correction amount adder 805 are newly added in place of the backlight emission rate adjustment resistor 212 and the emission rate multiplier 213 in the configuration of FIG. 2 of the first embodiment. The other components from the sub pixel maximum value selector 201 to the backlight control signal 217 are the same as those of the function block explained in FIG. 2 of the first embodiment, and therefore, the explanation thereof is omitted.

The higher-gradation side 255/n calculator 801 calculates 255/n in respect of a higher-gradation side expansion gradation value that is an output of the higher-gradation side averaging circuit 207, and transmits a higher-gradation expansion rate that is the calculation result to the higher-gradation side multiplier 802. The higher-gradation side multiplier 802 multiplies the higher-gradation side expansion rate transmitted from the higher-gradation side 255/n calculator 801 by each of the sub pixel gradation values of the display data 215, and transmits the multiplication result to the expansion difference subtracter 803.

The expansion difference subtracter 803 calculates a difference of each sub pixel between each calculation result from the higher-gradation side multiplier 802 and the display data after expansion 216, and transmits the calculation result to the averaging circuit for expansion differences for one screen 804. The averaging circuit for expansion differences for one screen 804 averages the differences for one screen in which the difference of each sub pixel is transmitted from the expansion difference subtracter 803, and transmits a backlight correction amount that is the average result to the correction amount adder 805. The correction amount adder 805 adds the backlight correction amount, which is transmitted from the averaging circuit for expansion differences for one screen 804, to the higher-gradation side expansion gradation value that is an output of the higher-gradation side averaging circuit 207, and transmits the addition result as a backlight emission amount to the PWM generator 214.

The flow of the entire process in the backlight control unit 104 according to the configuration described above is as follows. An explanation for from an input of the display data 215 to calculation of the display data after expansion 216 is the same as those of FIG. 2 of the first embodiment, and therefore, the explanation thereof is omitted. In the present embodiment, in order to generate the backlight control signal 217, first of all, the higher-gradation side expansion rate is calculated by the higher-gradation side 255/n calculator 801 based on the higher-gradation side expansion gradation value that is an output of the higher-gradation side averaging circuit 207. This expansion rate is multiplied by each of the sub pixel gradation values of the display data 215 to obtain the calculation result of pixel expansion on the higher-gradation side.

Next, the expansion difference subtracter 803 obtains the difference between the calculation result of pixel expansion on the higher-gradation side and the display data after expansion 216 that is the calculation result obtained by expanding both of the higher-gradation side and the lower-gradation side. Further, the averaging circuit for expansion differences for one screen 804 obtains the average of the differences for one screen as a backlight correction amount. The correction amount adder 805 adds the higher-gradation side expansion gradation value and the backlight correction amount to obtain a backlight emission amount. The PWM generator 214 converts the backlight emission amount into a PWM signal as the backlight control signal 217.

As described in the foregoing, in the present embodiment, the average value of the differences between the data expanded only on the higher-gradation side and the data expanded on both of the higher-gradation side and the lower-gradation side is a correction amount of the backlight. Since the backlight is darkened only according to information on the higher-gradation side, if the data expanded only on the higher-gradation side is displayed, the brightness becomes equivalent to that of the original image.

Because of this, the data expanded only on the higher-gradation side is presumed to be the reference brightness, and the difference between the data expanded only on the higher-gradation side and the data expanded on both of the higher-gradation side and the lower-gradation side is presumed to show how much brighter or darker the brightness is than the reference brightness. By averaging the differences for one screen, information that the display image is how much relatively brighter or darker than the original image, can be obtained, so that the backlight luminance can be properly corrected based on the information.

Although multipliers are used for the backlight emission control in the configurations of the first embodiment to the fifth embodiment, a similar effect can be obtained by backlight emission control with calculation of addition, subtraction, division, gamma transformation, and the like other than multiplication, and the backlight emission can be controlled by providing an adjustment resistor whose configuration is similar to those of the embodiments described above.

In the foregoing, the invention made by the inventors has been specifically explained based on the embodiments. However, it is needless to say the present invention is not limited to the foregoing embodiments and various modifications and alterations can be made within the scope of the present invention.

The present invention can be used for backlight control of a display device such as a liquid crystal display device, and can be applied to not only liquid crystal displays for cellular phones, but also compact media players such as a DVD player equipped with a liquid crystal display.

What is claimed is:

1. A display driver driving a display panel according to inputted display data, comprising:
a first circuit changing brightness of a display image by conversion of the display data based on a first reference value and a second reference value, the first reference value being a display data value at a first position in an upper part of a histogram of the inputted display data, and the second reference value being a display data value at a second position in a lower portion of the histogram;
a second circuit changing brightness of a illuminating device illuminating the display panel based on the first reference value; and
a control circuit performing a processing of making the brightness of the display image high by the first circuit and a processing of making the brightness of the illuminating device low by the second circuit in correlation with the brightness of the display image.

2. The display driver according to claim 1, further comprising a circuit capable of changing setting of the first position and the second position from an external control device of the display driver.

3. The display driver according to claim 1, further comprising a circuit capable of changing setting of a lower limit value of the first reference value and an upper limit value of the second reference value from an external control device of the display driver.

4. The display driver according to claim 1,
wherein a difference value between a highest position of the inputted display data and a lower limit value of the first reference value is larger than a difference value between an upper limit value of the second reference value and a lowest position of the inputted display data.

5. The display driver according to claim 1,
wherein when the display data value at the first position in the histogram is lower than a lower limit value of the first reference value, the control circuit uses the lower limit value of the first reference value as the first reference value, and
when the display data value at the second position in the histogram is higher than an upper limit value of the second reference value, the control circuit uses the upper limit value of the second reference value as the second reference value.

6. The display driver according to claim 1,
wherein the control circuit controls a voltage to the illuminating device or an emission amount of the illuminating device according to a value obtained by multiplying the first reference value by a constant value k.

7. The display driver according to claim 6, further comprising a circuit capable of changing setting of the constant value k from an external control device of the display driver.

8. A display driver driving a display panel according to inputted display data, comprising:
a first circuit changing brightness of a display image by conversion of the display data based on a first reference value and a second reference value, the first reference value being a display data value at a first position in an upper part of a histogram of the inputted display data, and the second reference value being a display data value at a second position in a lower portion of the histogram;
a second circuit changing brightness of a illuminating device illuminating the display panel based on the first reference value and the second position, or based on the first reference value, the second position, and the second reference value; and
a control circuit performing a processing of making the brightness of the display image high by the first circuit and a processing of making the brightness of the illuminating device low by the second circuit in correlation with the brightness of the display image.

9. The display driver according to claim 8, further comprising a circuit capable of changing setting of the first position and the second position from an external control device of the display driver.

10. The display driver according to claim 8, further comprising a circuit capable of changing setting of a lower limit value of the first reference value and an upper limit value of the second reference value from an external control device of the display driver.

11. The display driver according to claim 8,
wherein a difference value between a highest position of the inputted display data and a lower limit value of the first reference value is larger than a difference value between an upper limit value of the second reference value and a lowest position of the inputted display data.

12. The display driver according to claim 8,
wherein when the display data value at the first position in the histogram is lower than a lower limit value of the first reference value, the control circuit uses the lower limit value of the first reference value as the first reference value, and
when the display data value at the second position in the histogram is higher than an upper limit value of the second reference value, the control circuit uses the upper limit value of the second reference value as the second reference value.

13. The display driver according to claim 8,
wherein the control circuit controls a voltage to the illuminating device or an emission amount of the illuminating device according to a value obtained by multiplying the first reference value, the second position, and a constant value m.

14. The display driver according to claim 8,
wherein the control circuit controls a voltage to the illuminating device or an emission amount of the illuminating device according to a value obtained by multiplying a subtraction value of the second reference value from the upper limit value of the second reference value by the first reference value and the constant value m.

15. The display driver according to claim 13, further comprising a circuit capable of changing setting of the constant value m from an external control device of the display driver.

16. The display driver according to claim 8,
wherein the control circuit controls a voltage to the illuminating device or an emission amount of the illuminating device according to a value obtained by multiplying an average value for one frame obtained by averaging subtraction values in which the inputted display data is subtracted from display data outputted from the first circuit by the second reference value.

17. A display driver driving a display panel according to inputted display data, comprising:
in a case where a first reference value is a display data value at a first position in an upper part of the first position of a histogram of display data for one or a plurality of frames of the inputted display data, and a second reference value is a display data value at a second position in a lower portion of the histogram,
a first circuit changing a data value of the display data for one or the plurality of frames so as to shift the histogram to a lower side based on the second reference value, and so as to expand the entire histogram to a upper side based on the first reference value; and
a second circuit darkening a illuminating device illuminating the display panel according to an expansion rate of the entire histogram,
wherein the second circuit changes a darkening amount of the illuminating device based on the second reference value.

18. The display driver according to claim 17,
wherein when the second reference value is high, the darkening amount of the illuminating device is small, and when the second reference value is low, the darkening amount of the illuminating device is large.

19. The display driver according to claim 17,
wherein when a distribution in a lower part of the histogram is small, the second reference value is high, and when the distribution in the lower part of the histogram is large, the second reference value is low.

20. A display driver driving a display panel according to an inputted display data, comprising:
a first circuit eliminating an upper and a lower sides of a histogram of display data for one or a plurality of frames of the inputted display data, and changing a data value of the display data for the one or the plurality of frames such that the entire histogram is expanded so as to compensate an amount of an eliminated portion; and
a second circuit reducing power consumption of a illuminating device illuminating the display panel according to an expansion rate of the entire histogram,
wherein the second circuit makes a reduction amount of power of the illuminating device small when the eliminated amount of the lower side of the histogram is small, and makes the reduction amount of the power of the illuminating device large when the eliminated amount of the lower side of the histogram is large.

21. The display driver according to claim 20,
wherein when dark display data is small based on the histogram, the eliminated amount of the lower side of the histogram is large, and when the dark display data is large based on the histogram, the eliminated amount of the lower side of the histogram is small.
